(19) United States
(12) Patent Application Publication
(10) Pub. No.: US 2012/0290393 A1
(43) Pub. Date: Nov. 15, 2012

(54) USER CONTROLLED ADVERTISING PREFERENCES

(75) Inventors: Kay Johansson, Alamo, CA (US); Anders Norstrom, Alamo, CA (US)

(73) Assignee: MobiTV, Inc., Emeryville, CA (US)

(21) Appl. No.: 13/107,818

(22) Filed: May 13, 2011

(51) Int. Cl. G06Q 30/00

(52) U.S. Cl. 705/14.55

(57) ABSTRACT

Mechanisms provide content consumers with the ability to select types of advertising. Advertising types may include commercials for a particular brand or company, product placement type advertising, commercials interspersed between clips of content, advertising having a particular rating, or no advertising in exchange for payment of a fee or completion of a questionnaire. The advertisement type selections may also apply to different devices the user accesses to consume content, whether content is a movie played using a set top box, a banner advertisement shown alongside an article, or a product placed in a video game. The selections may be applied to a variety of devices associated with a user in a uniform or varying manner.

### TECHNICAL FIELD

The present disclosure relates to user controlled advertising preferences.

### DESCRIPTION OF RELATED ART

A variety of content and application providers rely on advertising to fund their services. The ability of advertising to sufficiently fund content and application providers is dependent on getting users to actually pay attention to advertising. Advertising may be placed before content is viewed, displayed alongside content, placed between content segments, etc. However, advertising is generally only roughly targeted and is commonly seen as an annoyance to be avoided. Some efforts have been made to make advertising more relevant. However, these efforts have been met with limited success.

Consequently, techniques and mechanisms are provided to improve the effectiveness of advertising.

### BRIEF DESCRIPTION OF THE DRAWINGS

The disclosure may best be understood by reference to the following description taken in conjunction with the accompanying drawings, which illustrate particular embodiments.

FIG. 1 illustrates a particular example a mechanism for providing advertisement type selection options.

FIG. 2 illustrates a particular example of a technique of advertisement selection.

FIG. 3 illustrates a network that can use user selected advertisement types.

FIG. 4 illustrates one example of a media content delivery system.

FIG. 5 illustrates a particular example of a computer system.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular types of content. However, it should be noted that the techniques of the present invention apply to a wide variety of content. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Mechanisms provide content consumers with the ability to select types of advertising. Advertising types may include commercials for a particular brand or company, product placement type advertising, commercials interspersed between clips of content, advertising having a particular rating, or no advertising in exchange for payment of a fee or completion of a questionnaire. The advertisement type selections may also apply to different devices the user accesses to consume content, whether content is a movie played using a set top box, a banner advertisement shown alongside an article, or a product placed in a video game. The selections may be applied to a variety of devices associated with a user in a uniform or varying manner.

### Example Embodiments

Presenting advertising that is interesting and relevant to a user in an unobstrusive manner is a continuing challenge. In many instances, users can simply ignore advertising, either by blocking a pop up window, ignoring a banner, skipping through a commercial, or flipping a page. Even when users do happen to consume an advertisement, the advertisement may not be particularly relevant to the user. In some examples, efforts are made to profile a user to allow for more targeted advertising. Advertising for a product marketed primarily for a particular demographic group may be placed with content having an audience having significant numbers from that particularly demographic group. Users may opt into personalized advertising and provide interest profiles, demographic data, preference information, etc., and generally targeted advertising may be provided to these users.

However, a variety of privacy concerns restrain many users from providing profile information to content providers and advertisers. Consequently, the techniques and mechanisms of the present invention provide users with the ability select types of advertising, such as categories of advertising, content of commercials, brands, etc., at a variety of points before or during a content consumption experience. For example, a user may select car commercials, real estate commercials, and movie trailers for viewing during running of a program on a television or running of an application on a mobile device. The selections may be specific to a particular piece of content, or can be general across all content consumed. The selections may also apply to different devices the user accesses to consume content, whether content is a movie played using a set top box, a banner advertisement shown alongside an article, or a product placed in a video game. The selections may be applied to a variety of devices associated with a user in a uniform or varying manner.

In some examples, a user may select car commercials, vacation commercials, and real estate commercials for viewing a mobile device while selecting vacation commercials and G-rated movie trailers for presentation on a living room television set. According to various embodiments, a user may select to view advertising before viewing content, may select advertising interspersed with content, or advertising integrated with content. In particular embodiments, the user may specify a preference for advertising overlays, banner advertisements, extended length advertisements, or an option to pay for an advertising free experience. According to various embodiments, the user may specify the level of detail, humor, explicit language, etc., included in advertising. A user provides specific information on advertisement presentation preferences without revealing too much private profile information, while advertisers and content providers have the ability to provide the user with advertising in a chosen format relating to content the user has professed interest in.

According to various embodiments, receiving user advertisement selections reduces the complexity required in profiling users. Advertising targeting is no longer reliant on user assessments based on past behavior or viewing activity. Advertisement type selections remove guesswork involved with providing relevant and unobstrusive advertising to users.

In particular embodiments, advertisement selections are managed so that there is an identification of what the user has selected to view on what devices and when. In some examples, a user may be elect to view advertising for alcohol only after 9 pm. In other examples, a user may be elect to view advertising for alcohol on a mobile device but not on a multiple user device such as a set top box. In still other examples, a user may elect to view advertising about particular pharmaceuticals for a limited period of time on a particular device.

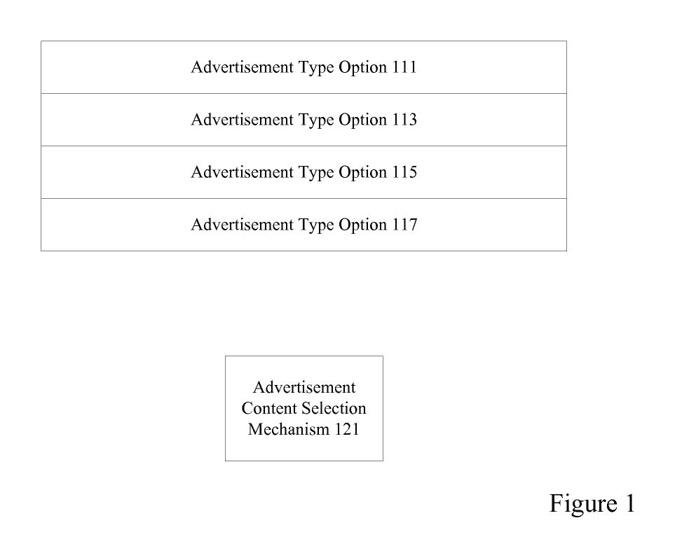

FIG. 1 illustrates an example of a mechanism for presenting advertisement type options. Advertisement type options 111, 113, 115, and 117 may provide options for different advertisement types. According to various embodiments, a first advertisement type may be advertisements for a particular brand, product, or company presented as video clips played periodically between program segments. In particular embodiments, a second advertisement type may be rotating banner advertisements at the bottom of a screen. In particular embodiments, a third advertisement type may be an advertisement overlay covering particular areas of a screen. Additional advertisement types may be advertisements associated with a partiular brand or company. Still other advertisements types may be advertisements corresponding to particular product categories, classes of goods and services, ratings, styles, and genres. According to various embodiments, one particular advertisement type option provides a user with the ability to view content advertisement free by paying a fee by responding to a series of questions.

Advertisement types may also include genres of advertising including advertising associated with action, action movies, or outdoor activities. In some examples, a user may also elect product placement based advertisement type, so that advertisements are integrated into the content itself.

Advertisement type selections may be provided to an advertisement content selection mechanism 121. According to various embodiments, the advertisement content selection mechanism may be integrated in a media content delivery server or included in a separate advertisement server. Advertisement type options 111, 113, 115, and 117 may be presented to a user on a variety of devices and at a variety of points in time. In some examples, the advertisement type options 111, 113, 115, and 117 are presented when a user initially uses a content viewing application such as a media player. According to various embodiments, the advertisement type options 111, 113, 115, and 117 are presented periodically, or prior to playback or a particular piece of content. In particular embodiments, the advertisement type options 111, 113, 115, and 117 are presented whenever a user has viewed advertisements of a particular advertisement type for a predetermined period of time or has exhausted available advertising of that particular type. New and/or different options may be provided to a user after a number of advertisements of a particular advertisement type have been viewed.

According to various embodiments, a user may elect to view advertisements associated with a particular brand, event, or advertising campaign. In particular embodiments, the advertising campaign may end, the user may have viewed all of the advertisements of a particular campaign, an event may have passed, or a particular company may have reduced an advertising budget. Different advertisement type options may be presented to the user to allow the user to select one or more different advertisement types.

In some examples, the user may select different advertisement types for different devices associated with the user, different types of content, different time periods, etc. The user may select one genre of advertising for a shared living room television and a different genre of advertising for a personal mobile device. In particular embodiments, the user may select banner type advertisements during news playback, product placement type advertising for movies, clip advertising for television programs, and G-rated advertising prior to 9 pm.

By supporting advertisement selections, advertising can be selected and/or generated in an environment where a user is known to prefer such advertising. Targeted and selected advertising can be provided to the user without having to deduce possible interests from prior content consumption history or possibly unreliable preference data.

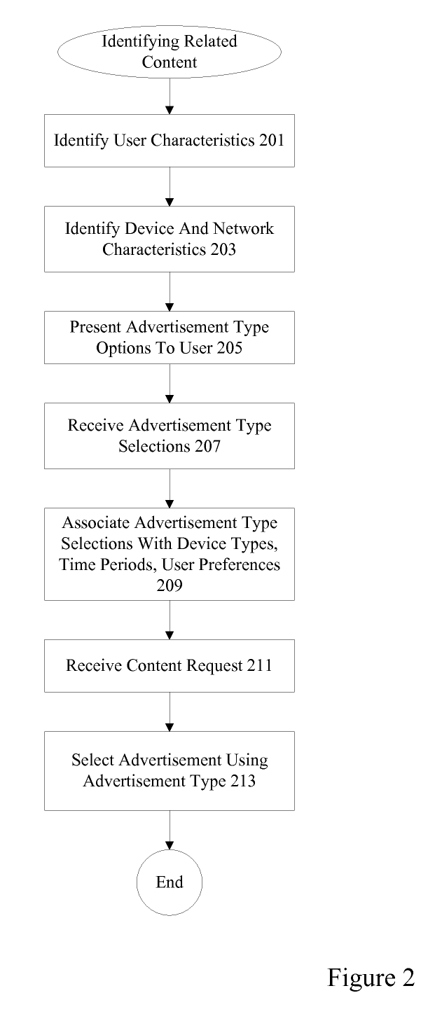

FIG. 2 illustrates one example of a technique for performing advertisement selection. According to various embodiments, user preferences are identified at 201. Although advertisement selections may not require user characteristics, user characteristic information can be used to supplement and augment user advertisement selections. User characteristics may include age, gender, ethnicity, income, viewing history, search history, etc., user characteristics may be used identify what advertisement options to provide to a user in the first place. However, it is recognized that providing advertising based on user characteristics has limited effectiveness. Users may not enter sufficient information due to privacy concerns. Viewing and search history may not provide an accurate indicator of what the user will be interested in viewing. Demographic data provides only a rough estimate of what users in a demographic group may tend to be interested in. Conesquently, the techniques and mechanisms of the present invention provide options for a user to select advertisement types.

The various types of advertising may be presented in a variety of sizes, resolutions, manners, and modes. In some examples, device and network characteristics are determined at 203 to determine the quality of the advertising to be provided to the user. High bandwidth, high processing power users may receive higher quality advertising or higher bandwidth consumption advertising. According to various embodiments, advertisement type options are presented to the user st 205. Advertisement type options may include advertisement free viewing, sponsorship by a particular brand or company, advertisements of a particular genre, etc. According to various embodiments, advertisement type selections are received at 207. Advertisement type selections may be received immediately prior to presentation of content, during periodic intervals, after a particular trigger by a user, etc. According to various embodiments, advertisement type selections may be received for different devices, types of content, times of day, etc. At 209, advertisement type selections are associated with device types, time periods, user preferences, etc. At 211, a content request is received. According to various embodiments, a content request may be received before advertisement type options are presented to a user. In particular embodiments, a content request may be processed at the same time advertisement type options are processed.

According to various embodiments, one or more advertisements such as commercials, banners, overlays, product placement sequences, offers, etc., may be selected for the user using the advertisement type selection information at 213. In particular embodiments, advertisements may be selected using advertisement type selection information along with user, device, network, and content characteristics.

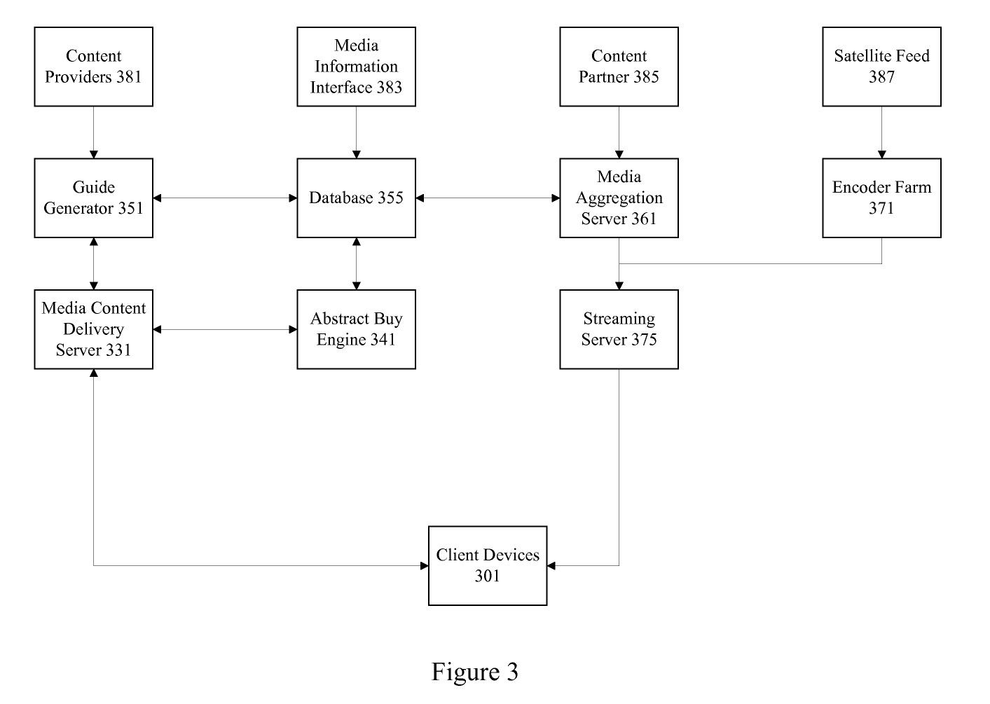

FIG. 3 is a diagrammatic representation showing one example of a network that can use the techniques of the present invention. According to various embodiments, media content that can include advertisements selected using advertisement type information is provided from a number of different sources 385. Although media content is described, it should be noted that the techniques and mechanisms of the present invention can apply to a variety of types of content, including text, video, audio, and image content. Media content may be provided from film libraries, cable companies, movie and television studios, commercial and business users, etc. and maintained at a media aggregation server 361. Any mechanism for obtaining media content from a large number of sources in order to provide the media content to mobile devices in live broadcast streams is referred to herein as a media content aggregation server. The media content aggregation server 361 may be clusters of servers located in different data centers. According to various embodiments, content provided to a media aggregation server 361 is provided in a variety of different encoding formats with numerous video and audio codecs. Media content may also be provided via satellite feed 357.

An encoder farm 371 is associated with the satellite feed 387 and can also be associated with media aggregation server 361. The encoder farm 371 can be used to process media content from satellite feed 387 as well as from media aggregation server 361 into potentially numerous encoding formats. According to various embodiments, file formats include open standards MPEG-1 (ISO/IEC 11172), MPEG-2 (ISO/IEC 13818-2), MPEG-4 (ISO/IEC 14496), as well as proprietary formats QuickTime™, ActiveMovie™, and RealVideo™. Some example video codecs used to encode the files include MPEG-4, H.263, and H.264. Some example audio codecs include Qualcomm Purevoice™ (QCELP), The Adaptive Multi-Narrow Band (AMR-NB), Advanced Audio coding (AAC), and AACPlus. The media content may also be encoded to support a variety of data rates. The media content from media aggregation server 361 and encoder farm 371 is provided as live media to a streaming server 375. In one example, the streaming server is a Real Time Streaming Protocol (RTSP) server 375. Media streams are broadcast live from an RTSP server 375 to individual client devices 301. A variety of protocols can be used to send data to client devices.

Possible client devices 301 include personal digital assistants (PDAs), cellular phones, smartphones, personal computing devices, personal computers etc. According to various embodiments, the client devices are connected to a cellular network run by a cellular service provider. In other examples, the client devices are connected to an Internet Protocol (IP) network. Alternatively, the client device can be connected to a wireless local area network (WLAN) or some other wireless network. Live media streams provided over RTSP are carried and/or encapsulated on one of a variety of wireless networks.

The client devices are also connected over a wireless network to a media content delivery server 331. The media content delivery server 331 is configured to allow a client device 301 to perform functions associated with accessing live media streams. For example, the media content delivery server allows a user to create an account, perform session identifier assignment, subscribe to various channels, log on, access program guide information, obtain information about media content, etc. According to various embodiments, the media content delivery server does not deliver the actual media stream, but merely provides mechanisms for performing operations associated with accessing media. In other implementations, it is possible that the media content delivery server also provides media clips, files, and streams. The media content delivery server is associated with a guide generator 351. The guide generator 351 obtains information from disparate sources including content providers 381 and media information sources 383. The guide generator 351 provides program guides to database 355 as well as to media content delivery server 331 to provide to client devices 301.

According to various embodiments, the guide generator 351 obtains viewership information from individual client devices. In particular embodiments, the guide generation 351 compiles viewership information in real-time in order to generate a most-watched program guide listing most popular programs first and least popular programs last. The client device 301 can request program guide information and the most-watched program guide can be provided to the client device 301 to allow efficient selection of video content. According to various embodiments, guide generator 351 is connected to a media content delivery server 331 that is also associated with an abstract buy engine 341. The abstract buy engine 341 maintains subscription information associated with various client devices 301. For example, the abstract buy engine 341 tracks purchases of premium packages.

The media content delivery server 331 and the client devices 301 communicate using requests and responses. For example, the client device 301 can send a request to media content delivery server 331 for a subscription to premium content. According to various embodiments, the abstract buy engine 341 tracks the subscription request and the media content delivery server 331 provides a key to the client device 301 to allow it to decode live streamed media content. Similarly, the client device 301 can send a request to a media content delivery server 331 for a most-watched program guide for its particular program package. The media content delivery server 331 obtains the guide data from the guide generator 351 and associated database 355 and provides appropriate guide information to the client device 301.

Although the various devices such as the guide generator 351, database 355, media aggregation server 361, etc. are shown as separate entities, it should be appreciated that various devices may be incorporated onto a single server. Alternatively, each device may be embodied in multiple servers or clusters of servers. According to various embodiments, the guide generator 351, database 355, media aggregation server 361, encoder farm 371, media content delivery server 331, abstract buy engine 341, and streaming server 375 are included in an entity referred to herein as a media content delivery system.

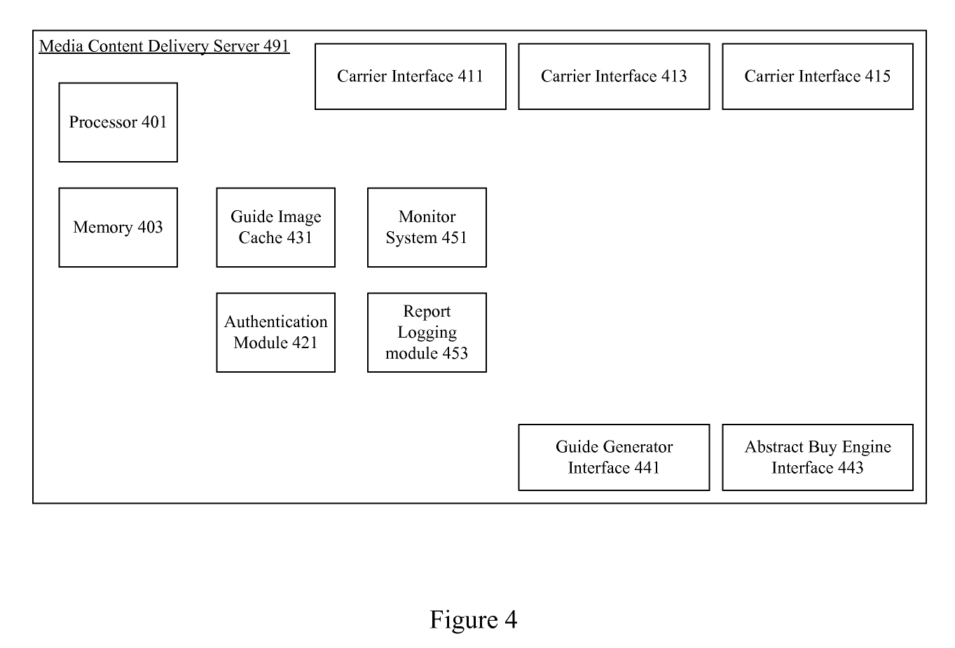

FIG. 4 is a diagrammatic representation showing one example of a media content delivery server 491. According to various embodiments, the media content delivery server 491 includes a processor 401, memory 403, and a number of interfaces. In some examples, the interfaces include a guide generator interface 441 allowing the media content delivery server 491 to obtain program guide information. The media content delivery server 491 also can include a program guide cache 431 configured to store program guide information and data associated with various channels. The media content delivery server 491 can also maintain static information such as icons and menu pages. The interfaces also include a carrier interface 411 allowing operation with mobile devices such as cellular phones operating in a particular cellular network. The carrier interface allows a carrier vending system to update subscriptions. Carrier interfaces 413 and 415 allow operation with mobile devices operating in other wireless networks. An abstract buy engine interface 443 provides communication with an abstract buy engine that maintains subscription information.

An authentication module 421 verifies the identity of mobile devices. A logging and report generation module 453 tracks mobile device requests and associated responses. A monitor system 451 allows an administrator to view usage patterns and system availability. According to various embodiments, the media content delivery server 491 handles requests and responses for media content related transactions while a separate streaming server provides the actual media streams. In some instances, a media content delivery server 491 may also have access to a streaming server or operate as a proxy for a streaming server. But in other instances, a media content delivery server 491 does not need to have any interface to a streaming server. In typical instances, however, the media content delivery server 491 also provides some media streams. The media content delivery server 491 can also be configured to provide media clips and files to a user in a manner that supplements a streaming server.

Although a particular media content delivery server 491 is described, it should be recognized that a variety of alternative configurations are possible. For example, some modules such as a report and logging module 453 and a monitor 451 may not be needed on every server. Alternatively, the modules may be implemented on another device connected to the server. In another example, the server 491 may not include an interface to an abstract buy engine and may in fact include the abstract buy engine itself. A variety of configurations are possible.

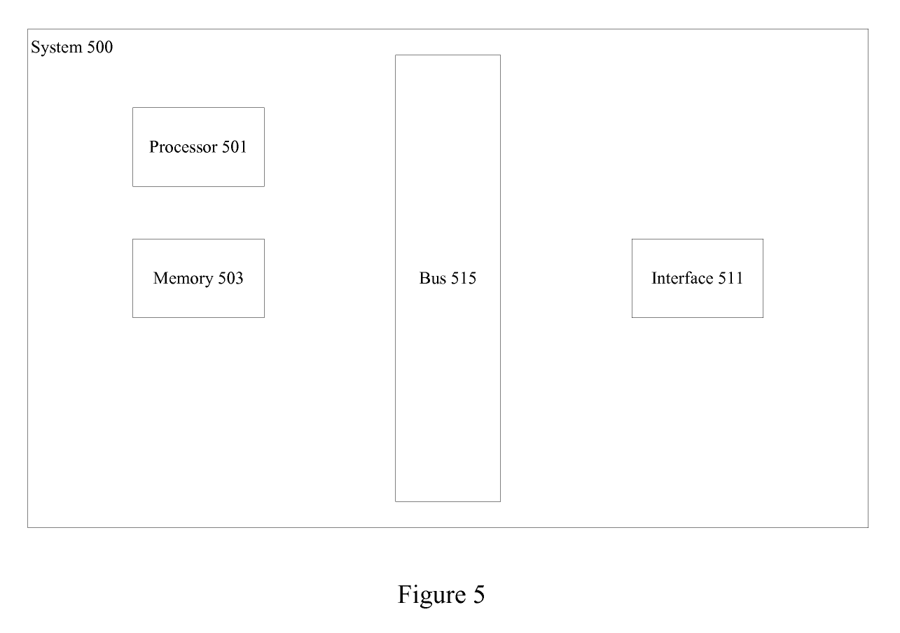

FIG. 5 illustrates one example of a server that can be used to perform advertisement option selection. According to particular embodiments, a system 500 suitable for implementing particular embodiments of the present invention includes a processor 501, a memory 503, an interface 511, and a bus 515 (e.g., a PCI bus or other interconnection fabric) and operates as a streaming server. When acting under the control of appropriate software or firmware, the processor 501 is responsible for modifying and transmitting live media data to a client. Various specially configured devices can also be used in place of a processor 501 or in addition to processor 501. The interface 511 is typically configured to end and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, the system 500 is a content server that also includes a transceiver, streaming buffers, and a program guide database. The content server may also be associated with subscription management, logging and report generation, and monitoring capabilities. In particular embodiments, functionality for allowing operation with mobile devices such as cellular phones operating in a particular cellular network and providing subscription management. According to various embodiments, an authentication module verifies the identity of devices including mobile devices. A logging and report generation module tracks mobile device requests and associated responses. A monitor system allows an administrator to view usage patterns and system availability. According to various embodiments, the content server 591 handles requests and responses for media content related transactions while a separate streaming server provides the actual media streams.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

1. A method, comprising:
identifying user information associated with a user;
generating a plurality of advertisement type options using the user information, the plurality of advertisement type options including a first option to view a first plurality of advertisements associated with a particular brand;
receiving a first selection for a first advertisement type option;
receiving a request for media content from the user;
presenting the first plurality of advertisements prior to completion of media content playback.

2. The method of claim 1, wherein the plurality of advertisement type options includes a second advertisement type option to view a second plurality of advertisements associated with a product category.

3. The method of claim 1, wherein the plurality of advertisement type options includes a second advertisement type option to view a second plurality of advertisements associated with a ratings level.

4. The method of claim 1, wherein the plurality of advertisement type options includes a second advertisement type option to view the media content commercial free in exchange for payment of a fee.

5. The method of claim 1, wherein the plurality of advertisement type options includes a second advertisement type option to view the media content after responding to a questionnaire.

6. The method of claim 1, wherein the plurality of advertisement type options includes a second advertisement type option to view the media content after viewing an extended commercial clip.

7. The method of claim 1, wherein the plurality of advertisement type options includes a second advertisement type option to view the media content interrupted by periodic commercial clips.

8. The method of claim 1, wherein the first selection for the first advertisement type option identifies a first target device.

9. The method of claim 8, wherein a second selection for a second advertisement type option identifies a second target device.

10. The method of claim 9, wherein the first target device is a mobile device.

11. The method of claim 1, wherein the first selection for the first advertisement type option identifies a first time period.

12. The method of claim 10, wherein a second selection for a second advertisement type option identifies a second period.

13. The method of claim 1, wherein user characteristics, device information, and network information is used to generate the plurality of advertisement type options.
